(19) United States
(12) Patent Application Publication
(10) Pub. No.: US 2021/0058929 A1
(43) Pub. Date: Feb. 25, 2021

(54) UPLINK TRANSMISSION RESOURCE ALLOCATION METHOD AND APPARATUS

(71) Applicant: HUAWEI TECHNOLOGIES CO., LTD., Shenzhen (CN)

(72) Inventors: Lei NING, Shenzhen (CN); Lang HE, Dongguan (CN); Longji ZENG, Shenzhen (CN); Aiying WANG, Shenzhen (CN)

(21) Appl. No.: 17/090,260

(22) Filed: Nov. 5, 2020

Related U.S. Application Data
(63) Continuation of application No. PCT/CN2018/086224, filed on May 9, 2018.

(51) Int. Cl. H04W 72/04; H04W 72/14

(52) U.S. Cl. CPC H04W 72/0453; H04W 72/14

(57) ABSTRACT

Embodiments of this application disclose an uplink transmission resource allocation method and apparatus. The uplink transmission resource allocation method and the apparatus may reduce resource fragments of an uplink transmission resource, increase an uplink peak rate of a cell, and improve spectrum utilization efficiency. The method may include: determining uplink data transmission grant instruction duration, first state transition duration, and duration of first uplink data transmission; and determining a target subcarrier based on the uplink data transmission grant instruction duration, the first state transition duration, and the duration of the first uplink data transmission, where the target subcarrier is an available subcarrier with a minimum difference between a start slot of uplink data transmission duration and an end slot of an allocated resource on an available subcarrier, and the available subcarrier is a subcarrier whose resource within the uplink data transmission duration is an idle resource.

### CROSS-REFERENCE TO RELATED APPLICATIONS

This application is a continuation of International Application No. PCT/CN2018/086224, filed on May 9, 2018, the disclosure of which is hereby incorporated by reference in its entirety.

### TECHNICAL FIELD

This application relates to the field of communications technologies, and in particular, to an uplink transmission resource allocation method and apparatus.

### BACKGROUND

Internet of everything makes everything more interrelated through network connections. The development of internet of things accelerates the process of internet of everything, enables more effective collection and transmission of various information, and promotes the development of human society.

A low power wide area network (LPWAN) is oriented to communication demands for a long distance and low power consumption in the internet of things, and features a long transmission distance, a large quantity of connected nodes, low power consumption of a terminal, and low operation and maintenance costs.

As one of LPWAN technologies, cellular internet of things (CIoT) is a half-duplex cellular communications system introduced in R13 by the international standards organization third generation partnership project (3GPP), and is deployed by operators in a licensed spectrum and is widely used in internet of things services such as smart meter reading, smart parking, and health monitoring.

The application characteristic of internet of things data collection determines that terminal services are mainly uplink transmission. Efficient uplink transmission can significantly improve spectrum utilization, shorten a terminal transmission time, and reduce node power consumption.

CIoT is a half-duplex cellular communications system. When performing uplink data transmission, a terminal needs to monitor an uplink data transmission grant instruction, and state transition between listening and uplink data transmission needs to comply with a specific time constraint.

As shown in FIG. 1, T1 indicates duration of an uplink data transmission grant instruction in which a terminal monitors; T3 indicates duration of the uplink data transmission performed by the terminal; T2 and T4 are time sequence constraints for state transition between the uplink transmission and downlink transmission performed by the terminal; T1 appears periodically, so that T5 is duration of a next uplink data transmission grant instruction that the terminal waits for.

T1 to T5 constitute a time sequence constraint of each phase of the uplink data transmission of a single terminal in the half-duplex cellular communications system.

A single terminal needs to meet the preceding time sequence requirements during uplink data transmission. Therefore, when multiple terminals multiplex uplink transmission resources, unavailable resource fragments may exist, reducing an uplink peak rate of a cell.

### SUMMARY

Embodiments of this application provide an uplink transmission resource allocation method and apparatus, to reduce resource fragments of an uplink transmission resource, increase an uplink peak rate of a cell, improve spectrum utilization, and reduce node power consumption.

To achieve the foregoing objectives, the following technical solutions are used in the embodiments of this application.

According to a first aspect, this application provides an uplink transmission resource allocation method and apparatus.

In an embodiment, the method may include: determining uplink data transmission grant instruction duration, first state transition duration, and duration of first uplink data transmission; and determining a target subcarrier based on the uplink data transmission grant instruction duration, the first state transition duration, and the duration of the first uplink data transmission, where the target subcarrier is an available subcarrier with a minimum difference between a start slot of uplink data transmission duration and an end slot of an allocated resource on an available subcarrier, and the available subcarrier is a subcarrier whose resource within the uplink data transmission duration is an idle resource. In the method, the available subcarrier with the minimum difference between the start slot of the uplink data transmission duration and the end slot of the allocated resource on the available subcarrier is determined as the target subcarrier, and a resource is allocated to a user on the target subcarrier, which can reduce resource fragments of an uplink transmission resource and increase an uplink peak rate of a cell.

In an embodiment, before the duration of the first uplink data transmission is determined, a quantity of subframes of the first uplink data transmission is determined based on a user buffer status report; and the duration of the first uplink data transmission is determined based on the quantity of subframes of the first uplink data transmission.

In an embodiment, if it is determined that no target subcarrier exists, second state transition duration is determined; and the target subcarrier is determined based on the uplink data transmission grant instruction duration, the second state transition duration, and the duration of the first uplink data transmission. In the method, if the target subcarrier cannot be determined for the user based on current state transition duration, a value of state transition duration is re-determined, and an uplink transmission resource is attempted to be allocated to the user, so that the uplink transmission resource is successfully allocated to the user as much as possible, thereby reducing resource fragments of the uplink transmission resource and increasing the uplink peak rate of the cell.

In an embodiment, if it is determined that no target subcarrier exists, a quantity of subframes of second uplink data transmission is redetermined as a quantity of subframes of uplink data transmission, where the quantity of subframes of the second uplink data transmission is equal to the quantity of subframes of the first uplink data transmission minus 1, and the quantity of subframes of the first uplink data transmission is an integer greater than 1; duration of the second uplink data transmission is determined based on the quantity of subframes of the second uplink data transmission; third state transition duration is re-determined as the state transition duration, where the third state transition duration is an initial value of the state transition duration; and the target subcarrier is determined based on the uplink data transmission grant instruction duration, the third state transition duration, and the duration of the second uplink data transmission. In the method, if the target subcarrier cannot be determined for the user based on current uplink data transmission duration, the quantity of subframes of uplink data transmission is reduced, and a value of the uplink data transmission duration is re-determined. An uplink transmission resource is attempted to be allocated to the user, so that the uplink transmission resource is successfully allocated to the user as much as possible, thereby reducing resource fragments of the uplink transmission resource and increasing the uplink peak rate of the cell. In addition, because the value of the uplink data transmission duration is re-determined, optional state transition duration restricted by a protocol may be re-traversed. For example, the initial value of the state transition duration is determined as the state transition duration, and the initial value of the state transition duration is a smallest value in the optional state transition duration. In this way, resource fragments of the uplink transmission resource can be reduced.

In an embodiment, a quantity of available subcarriers are determined based on the uplink data transmission grant instruction duration, the first state transition duration, and the duration of the first uplink data transmission; and the target subcarrier is determined from the available subcarriers.

In an embodiment, that it is determined that no target subcarrier exists specifically includes: determining that the quantity of available subcarriers is 0.

In an embodiment, after the determining a target subcarrier, an uplink data transmission grant instruction is sent to user equipment, the uplink data transmission grant instruction includes the uplink data transmission grant instruction duration, the state transition duration, uplink data transmission duration indication information, and the corresponding target subcarrier, where the uplink data transmission duration indication information is used to determine the uplink data transmission duration.

Correspondingly, this application further provides an uplink transmission resource allocation apparatus, and the apparatus may implement the uplink transmission resource allocation method according to the first aspect. For example, the apparatus may be a network device or a chip applied to the network device, or may be another apparatus that can implement the foregoing uplink transmission resource allocation method. The apparatus may implement the foregoing method by using software, hardware, or hardware executing corresponding software.

In an embodiment, the apparatus may include a processor and a memory. The processor is configured to support the apparatus in performing a corresponding function in the method according to the first aspect. The memory is configured to be coupled to the processor, and store a program instruction and data that are necessary for the apparatus. In addition, the apparatus may further include a communications interface. The communications interface is configured to support communication between the apparatus and another apparatus. The communications interface may be a transceiver or a transceiver circuit.

In an embodiment, the apparatus may include a determining module. The determining module is configured to determine uplink data transmission grant instruction duration, first state transition duration, and duration of first uplink data transmission; the determining module is further configured to determine a target subcarrier based on the uplink data transmission grant instruction duration, the first state transition duration, and the duration of the first uplink data transmission, where the target subcarrier is an available subcarrier with a minimum difference between a start slot of uplink data transmission duration and an end slot of an allocated resource on an available subcarrier, and the available subcarrier is a subcarrier whose resource within the uplink data transmission duration is an idle resource.

In an embodiment, the determining module is further configured to: before the determining duration of first uplink data transmission, determine a quantity of subframes of the first uplink data transmission according to a user buffer status report; and the determining module is further specifically configured to determine the duration of the first uplink data transmission based on the quantity of subframes of the first uplink data transmission.

In an embodiment, the determining module is further configured to: determine whether the target subcarrier exists; if it is determined that no target subcarrier exists, determine second state transition duration; and determine the target subcarrier based on the uplink data transmission grant instruction duration, the second state transition duration, and the duration of the first uplink data transmission.

In an embodiment, the determining module is further configured to: if it is determined that no target subcarrier exists, determine duration of second uplink data transmission based on a quantity of subframes of the second uplink data transmission; determine third state transition duration, where the quantity of subframes of the second uplink data transmission is equal to the quantity of subframes of the first uplink data transmission minus 1, and the quantity of subframes of the first uplink data transmission is an integer greater than 1, and the third state transition duration is an initial value of state transition duration; and determine the target subcarrier based on the uplink data transmission grant instruction duration, the third state transition duration, and the duration of the second uplink data transmission.

In an embodiment, the determining module determines a quantity of available subcarriers based on the uplink data transmission grant instruction duration, the first state transition duration, and the duration of the first uplink data transmission, and determines the target subcarrier from the available subcarriers.

In an embodiment, that the determining module determines that no target subcarrier exists includes: determining that the quantity of the available subcarriers is 0.

In an embodiment, the apparatus further includes a sending module. The sending module is configured to send an uplink data transmission grant instruction to user equipment after the determining module determines the target subcarrier, where the uplink data transmission grant instruction includes the uplink data transmission grant instruction duration, the state transition duration, uplink data transmission duration indication information, and the corresponding target subcarrier, where the uplink data transmission duration indication information is used to determine the uplink data transmission duration.

This application further provides a computer-readable storage medium. The computer-readable storage medium stores an instruction. When the instruction runs in a computer, the computer is enabled to perform the method according to any one of the foregoing aspects.

This application further provides a computer program product including an instruction. When the computer program product runs in a computer, the computer is enabled to perform the method according to any one of the foregoing aspects.

This application further provides a chip system. The chip system includes a processor, and may further include a memory, configured to implement the method according to any one of the foregoing aspects.

This application provides a communications system, including the foregoing apparatus configured to implement the uplink transmission resource allocation method according to the first aspect.

Any apparatus, computer storage medium, computer program product, chip system, or communications system provided above is configured to perform the corresponding method provided above. Therefore, beneficial effects that can be achieved by the apparatus, computer storage medium, computer program product, chip system, or communications system provided above, refer to beneficial effects of a corresponding solution in the corresponding method provided above. Details are not described herein again.

### BRIEF DESCRIPTION OF DRAWINGS

FIG. 1 is a schematic diagram of a time sequence constraint of each phase of uplink data transmission of a single terminal in a half-duplex cellular communications system;

FIG. 2 is a schematic diagram of a system architecture to which technical solutions provided in embodiments of this application are applicable;

FIG. 3 is a schematic structural diagram of a network device to which technical solutions provided in the embodiments of this application are applicable;

FIG. 4A and FIG. 4B are schematic diagrams of an uplink transmission resource allocation method according to an embodiment of this application;

FIG. 5 is a schematic diagram 1 of an uplink transmission resource allocation apparatus according to an embodiment of this application;

FIG. 6 is a schematic diagram 2 of an uplink transmission resource allocation apparatus according to an embodiment of this application; and

FIG. 7 is a schematic diagram 3 of an uplink transmission resource allocation apparatus according to an embodiment of this application.

### DESCRIPTION OF EMBODIMENTS

The following describes in detail an uplink transmission resource allocation method and apparatus provided in the embodiments of this application with reference to the accompanying drawings.

The technical solutions provided in this application may be applied to various half-duplex communications systems, for example, a current 4G communications system, a future evolved network such as a 5G communications system, a long term evolution (LTE) system, a cellular system related to the third generation partnership project (third generation partnership project, 3GPP), various communication convergence systems, and the like. In particular, the technical solutions may be applied to a CIoT system, for example, a narrowband internet of things (NB-IoT) system complying with a 3GPP specification. A plurality of application scenarios may be included, for example, including scenarios such as machine to machine (M2M), device to machine (D2M), macro-micro communication, enhanced mobile broadband (eMBB), ultra-reliable low-latency communication (uRLLC) and massive machine-type communication (mMTC). These scenarios may include but are not limited to: a scenario of communication between user equipment (UE) and UE, a scenario of communication between network devices, a scenario of communication between a network device and UE, and the like.

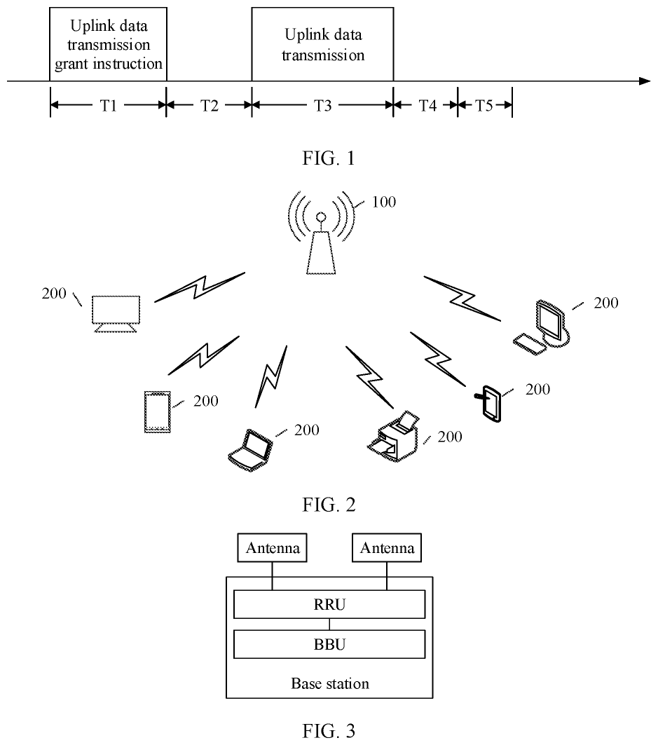

The technical solutions provided in the embodiments of this application may be applied to a system architecture shown in FIG. 2. The system architecture may include a network device 100 and one or more UEs 200 connected to the network device 100.

The network device 100 may be a device that can communicate with the UE 200. The network device 100 may be a relay station, an access point, or the like. The network device 100 may be an eNB (evolutional NodeB) or an eNodeB in LTE. The network device 100 may also be a radio controller in a cloud radio access network (CRAN) scenario. The network device 100 may also be a network device in a future 5G network or a network device in a future evolved network, or may be a wearable device, vehicle-mounted device, or the like.

The UE 200 may be an internet of things terminal, an access terminal, a UE unit, a UE station, a mobile station, a mobile console, a remote station, a remote terminal, a mobile device, a UE terminal, a terminal, a wireless communications device, a UE agent, a UE apparatus, or the like. The internet of things terminal implements functions of collecting data and sending data to the network device 100, and is responsible for multiple functions such as data collection, preliminary processing, encryption, and transmission. The internet of things terminal may be a shared bicycle, a water meter, an electricity meter, a street lamp, a fire alarm, and a manhole cover. The access terminal may be a cellular phone, a cordless phone, a session initiation protocol (SIP) phone, a wireless local loop (WLL) station, a personal digital assistant (PDA), a hand-held device with a wireless communication function, a computing device, another processing device connected to a wireless modem, a vehicle-mounted device, a wearable device, a terminal in the future 5G network, a terminal in the future evolved network, or the like.

It should be noted that the system architecture shown in FIG. 2 is merely used as an example, and is not intended to limit the technical solutions in this application. A person skilled in the art should understand that, in a specific implementation process, the system architecture may further include another device, and the network device 100 and the UE 200 may also be configured based on a specific requirement.

The uplink transmission resource allocation method and apparatus provided in the embodiments of this application may be applied to a network device. In an example, the network device 100 is a base station and a general hardware architecture of the network device 100 is described. As shown in FIG. 3, a base station may include a building baseband unit (BBU) and a remote radio unit (RRU). The RRU is connected to an antenna feeder system (that is, an antenna). The BBU and the RRU may be disassembled for use as required. It should be noted that in a specific implementation process, the network device 100 may also use another general hardware architecture, which is not limited to the general hardware architecture shown in FIG. 3. In the embodiments of this application, a specific structure of an entity that performs the uplink transmission resource allocation method is not particularly limited in the embodiments of this application, provided that a program that records code of the uplink transmission resource allocation method in the embodiments of this application can be run to perform communication according to the uplink transmission resource allocation method in the embodiments of this application. For example, the uplink transmission resource allocation method provided in the embodiments of this application may be performed by a base station, or may be performed by a function module that is in the base station and that can invoke and execute the program, or may be performed by an uplink transmission resource allocation apparatus applied to the base station, for example, a chip. This is not limited in this application. In this specification, an example in which the base station performs the foregoing uplink transmission resource allocation method is used for description.

The following explains and describes some terms in this application, to help a reader have a better understanding.

1. Uplink Data Transmission Grant Instruction Duration, State Transition Duration, and Uplink Data Transmission Duration

In a half-duplex communications system, a base station periodically sends an uplink data transmission grant instruction to UE, and the UE obtains time domain and frequency domain resources of uplink data transmission by listening to the uplink data transmission grant instruction. Time for uplink data transmission by UE is determined based on an uplink data transmission grant instruction received by the UE. Specifically, the uplink data transmission grant instruction includes uplink data transmission grant instruction duration T1, state transition duration, and indication information of uplink data transmission duration T3, and the state transition duration may include state transition duration 1 T2 and state transition duration 2 T4, the indication information of the uplink data transmission duration T3 is used to determine T3. For single UE, T1, T2, T3, T4, and T5 meet time sequence requirements shown in FIG. 1. The UE may determine, based on a moment at which the uplink data transmission grant instruction is monitored, T1, and T2, a start moment at which the UE performs the uplink data transmission; with reference to the start moment of the uplink data transmission, the UE may determine, based on T3, an end moment for performing the uplink data transmission.

2. Uplink Transmission Resource

The base station and the UE may perform data transmission by using an air interface resource. The air interface resource may include a time domain resource and a frequency domain resource, and the time domain resource and the frequency domain resource may also be referred to as a time-frequency resource. A direction in which the base station sends signaling and data to the UE is generally referred to as a downlink, and a direction in which the UE sends signaling and data to the base station is generally an uplink. An uplink time-frequency resource in the air interface resource is an uplink transmission resource. Each UE occupies the uplink transmission resource when performing uplink data transmission. The base station needs to properly allocate an independent uplink transmission resource to each UE, so that different UEs can multiplex the uplink transmission resource. In this application, the uplink transmission resource may be a subcarrier. On each subcarrier, different UEs multiplex time-frequency resources of the subcarrier.

3. The term “a plurality of” in this specification means two or more. Terms such as “first” and “second” in this specification are used to distinguish between different objects, but are not used to describe a specific order of the objects. For example, “first state transition duration” and “second state transition duration” are used to distinguish between different state transition duration, instead of describing a specific order of the state transition duration. The term “and/or” in this specification describes only an association relationship for describing associated objects and represents that three relationships may exist. For example, A and/or B may represent the following three cases: only A exists, both A and B exist, and only B exists.

In the embodiments of this application, a word or phrase such as “example” or “for example” is used to represent an example, an illustration, or a description. Any embodiment or design scheme described as “example” or “for example” in the embodiments of this application should not be explained as being more preferred or having more advantages than another embodiment or design scheme. Exactly, using the word or phrase such as “example” or “for example” is intended to present a relative concept in a specific manner.

As described above, on each subcarrier, different UEs multiplex the time-frequency resources of the subcarrier. When allocating an uplink transmission resource to each UE, the base station needs to ensure that the uplink transmission resource allocated to the UE is not occupied by another UE. Because a time sequence of uplink data transmission performed by the UE needs to meet the time sequence constraint shown in FIG. 1, when multiple UEs multiplex a subcarrier, there may be resource fragments that cannot be used. When the base station allocates an uplink transmission resource to UE, if resource fragments can be reduced as much as possible, spectrum utilization can be improved and an uplink peak rate of a cell can be increased. In the embodiments of this application, an example in which the base station performs the foregoing uplink transmission resource allocation method is used for description. For example, in the embodiments, the base station receives a user buffer status report sent by UE 1, and the base station schedules the UE 1, needs to allocate an uplink data transmission resource to the UE 1, and notifies, by using an uplink data transmission grant instruction, the UE 1 of the uplink data transmission resource allocated to the UE 1.

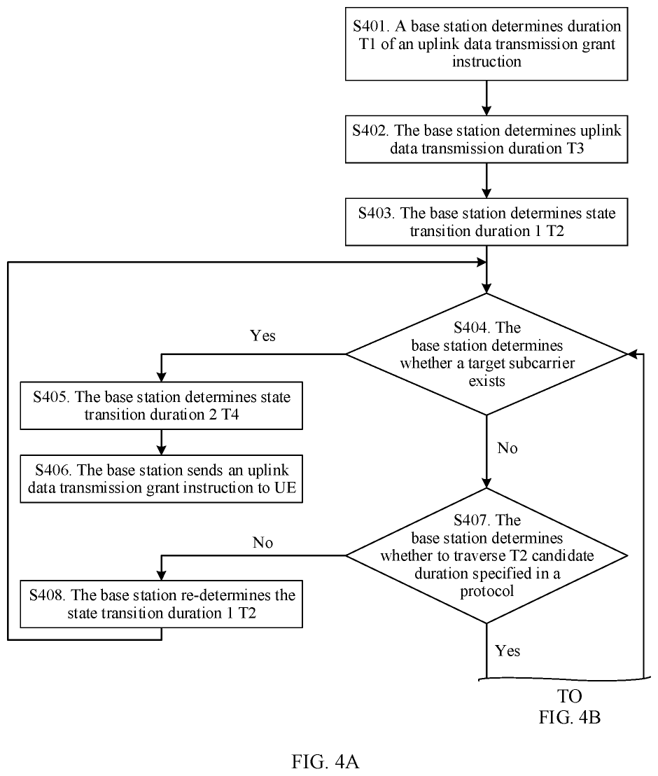

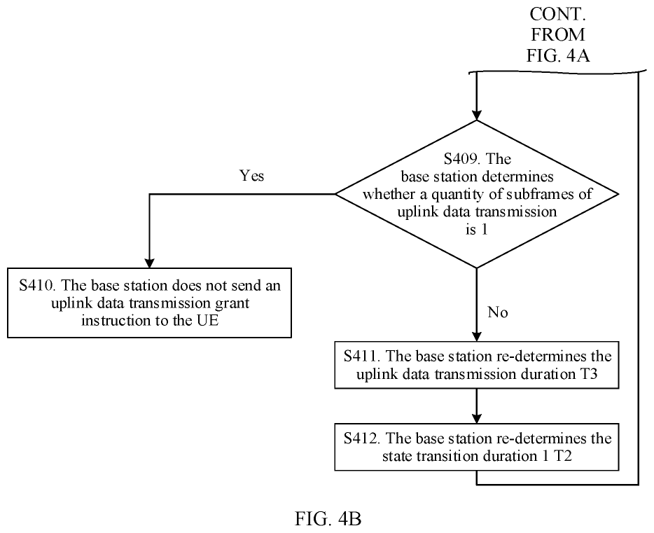

An embodiment of this application provides an uplink transmission resource allocation method, and the method may be applied to the communications system shown in FIG. 2. The uplink transmission resource allocation method provided in this embodiment of this application can reduce resource fragments and increase an uplink peak rate of a cell. As shown in FIG. 4A and FIG. 4B, the method may include S401 to S412.

S401. A base station determines duration T1 of an uplink data transmission grant instruction.

In an embodiment, the duration T1 of the uplink data transmission grant instruction may be pre-configured on the base station. For example, duration of the uplink data transmission grant instruction is pre-configured to 1 ms. The base station may determine the value of T1 according to a pre-configured value.

In an embodiment, before determining T1, the base station further determines a sending moment of the uplink data transmission grant instruction. For example, in NB-IoT, the base station periodically sends the uplink data transmission grant instruction to UE according to preset duration. For example, if the preset duration is 16 ms, the base station sends the uplink data transmission grant instruction to the UE every 16 ms. The base station may determine, based on a moment at which the uplink data transmission grant instruction is sent to UE 1 last time and the preset duration, a sending moment at which the uplink data transmission grant instruction is sent to the UE 1 this time, for example, a start slot for sending the uplink data transmission grant instruction.

S402. The base station determines uplink data transmission duration T3.

In an embodiment, if UE has to-be-sent uplink data, the UE sends a user buffer status report to the base station, where the user buffer status report includes a data volume of the to-be-sent uplink data of the UE. The base station receives the user buffer status report sent by the UE, and obtains the data volume of the to-be-sent uplink data of the UE.

The base station determines a quantity of subframes of first uplink data transmission based on the data volume of the to-be-sent uplink data of the UE in the user buffer status report and a protocol constraint.

For example, Table 1 lists a transport block size (TBS) configuration of a narrowband physical uplink shared channel (Narrowband Physical Uplink Shared Channel, NPUSCH) in the NB-IoT 3GPP R13 protocol.

I_{TBS} indicates a TBS index. Generally, a larger value of an I_{TBS} row index indicates better channel quality of UE. For example, in a cell peak scenario, a maximum index value is used as the I_{TBS} row index of all UEs; the numbers in the table indicate data volumes of uplink data in the unit of bit; an I_{TBS} value corresponds to an I_{TBS} column index, and I_{RU} indicates a quantity of subframes. I_{TBS} column indexes {0, 1, 2, 3, 4, 5, 6, 7} correspond to I_{RU} values {1, 2, 3, 4, 5, 6, 8, 10} respectively.

For example, the base station receives the user buffer status report sent by the UE, where the data volume of the to-be-sent uplink data of the UE is 900 bits; in a cell peak scenario, the I_{TBS} row index value is 12, a minimum value greater than 900 is 1000 in a row whose I_{TBS} row index is 12, and a corresponding I_{TBS} column index is 3. In this case, it may be determined that a corresponding quantity of subframes is 4, that is, it is determined that the quantity of subframes of the first uplink data transmission is 4. It should be noted that, if the base station does not obtain the user buffer status report sent by the UE when determining the quantity of subframes of the uplink data transmission, the base station may determine a default quantity of subframes of the uplink data transmission according to an actual situation. For example, it may be determined that an I_{TBS} column index is 0, and a corresponding quantity of subframes is 1.

Further, the base station determines duration of the first uplink data transmission based on the quantity of subframes of the first uplink data transmission. T3 is the duration of the first uplink data transmission, and the duration of the first uplink data transmission is equal to the quantity of subframes of the first uplink data transmission multiplied by single-subframe transmission duration.

In an embodiment, when the base station allocates a subcarrier time-frequency resource to the UE, single UE may occupy a frequency domain resource of one or more subcarriers. For example, in an NB-IoT system, a quantity of subcarriers is 12, a quantity of subcarriers that can be occupied by single UE is {1, 3, 6, 12}, and corresponding single-subframe transmission duration is {8 ms, 4 ms, 2 ms, 1 ms} respectively. For example, if single UE performs single-carrier transmission, that is, the single UE occupies a frequency domain resource of one subcarrier, single-subframe transmission duration is 8 ms. T3=4*8 ms.

TABLE 1

| | I_{RU} | | | | | | | |
|---|---|---|---|---|---|---|---|---|
| I_{TBS} | 0 | 1 | 2 | 3 | 4 | 5 | 6 | 7 |
| 0 | 16 | 32 | 56 | 88 | 120 | 152 | 208 | 256 |
| 1 | 24 | 56 | 88 | 144 | 176 | 208 | 256 | 344 |
| 2 | 32 | 72 | 144 | 176 | 208 | 256 | 328 | 424 |
| 3 | 40 | 104 | 176 | 208 | 256 | 328 | 440 | 568 |
| 4 | 56 | 120 | 208 | 256 | 328 | 408 | 552 | 680 |
| 5 | 72 | 144 | 224 | 328 | 424 | 504 | 680 | 872 |
| 6 | 88 | 176 | 256 | 392 | 504 | 600 | 808 | 1000 |
| 7 | 104 | 224 | 328 | 472 | 584 | 712 | 1000 | |
| 8 | 120 | 256 | 392 | 536 | 680 | 808 | | |
| 9 | 136 | 296 | 456 | 616 | 776 | 936 | | |
| 10 | 144 | 328 | 504 | 680 | 872 | 1000 | | |
| 11 | 176 | 376 | 584 | 776 | 1000 | | | |
| 12 | 208 | 440 | 680 | 1000 | | | | |

S403. The base station determines state transition duration 1 T2.

In an embodiment, the base station determines a value of the state transition duration 1 T2 according to a protocol constraint. For example, in an NB-IoT system, T2 candidate duration specified in the 3GPP protocol is {8 ms, 16 ms, 32 ms, 64 ms}.

In an embodiment, the base station determines that the value of T2 is first state transition duration. For example, the base station determines a minimum value in the T2 candidate duration specified in the 3GPP protocol as the first state transition duration. For example, a minimum value 8 ms in {8 ms, 16 ms, 32 ms, 64 ms} is selected as the first state transition duration. It should be noted that, in specific implementation, relatively small state transition duration is generally selected, so that uplink transmission resources can be saved.

S404. The base station determines whether a target subcarrier exists. If it is determined that the target subcarrier exists, S405 is performed; if it is determined that no target subcarrier exists, S407 is performed.

In an embodiment, the base station determines the target subcarrier based on the uplink data transmission grant instruction duration, the first state transition duration, and the duration of the first uplink data transmission.

In an embodiment, the base station determines a quantity of available subcarriers based on the uplink data transmission grant instruction duration, the first state transition duration, and the duration of the first uplink data transmission, where the available subcarrier is a subcarrier whose resource within the uplink data transmission duration is an idle resource. Specifically, the base station may determine a start slot for the uplink data transmission, that is, a start slot of the uplink data transmission duration T3 based on the start slot in which the uplink data transmission grant instruction is sent to the UE 1, T1, and T2, and determine an end slot for the uplink data transmission based on the start slot of T3 and the uplink data transmission duration T3. If a resource of a subcarrier in the uplink data transmission duration (between the start slot of the uplink data transmission and the end slot of the uplink data transmission) is not occupied by another UE and is a space resource, it is determined that the subcarrier is an available subcarrier. The base station traverses the subcarriers to determine a quantity of available subcarriers.

Further, the base station determines that the target subcarrier is an available subcarrier with a minimum difference between the start slot of the uplink data transmission duration and an end slot of an allocated resource on the available subcarrier. Optionally, if differences between the start slot of the uplink data transmission duration and end slots of allocated resources on a plurality of available subcarriers are equal, and the differences are less than differences between the start slot of the uplink data transmission duration and end slots of allocated resources on remaining available subcarriers, the base station may randomly select any one of the plurality of available subcarriers whose differences are equal as the target subcarrier.

For example, in an NB-IoT system, the base station has 12 subcarriers: subcarrier 1, subcarrier 2, subcarrier 3, subcarrier 4, subcarrier 5, subcarrier 6, a subcarrier 7, subcarrier 8, subcarrier 9, and subcarrier 10, subcarrier 11 and subcarrier 12.

In an embodiment, single UE occupies a time-frequency resource of one subcarrier. The base station determines that a start slot for sending the uplink data transmission grant instruction to the UE1 is T, T1 is 1 ms, T2 is 8 ms, and T3=4*8 ms=32 ms. The base station traverses 12 subcarriers, and determines that a subcarrier whose start slot is T+1 ms+8 ms and whose end slot is within T+1 ms+8 ms+32 ms and that is an idle resource is an available subcarrier. For example, subcarrier 1, subcarrier 3, subcarrier 8, and subcarrier 12 are determined as available subcarriers. The base station determines a subcarrier with a minimum difference between a slot (T+1 ms+8 ms) in the subcarrier 1, the subcarrier 3, the subcarrier 8, and the subcarrier 12 and an end slot of an allocated resource on the subcarrier as the target subcarrier.

In another embodiment, single UE occupies time-frequency resources of a plurality of subcarriers. For example, single UE occupies time-frequency resources of three subcarriers. Subcarriers 1, 2, and 3 belong to subcarrier group 1; subcarriers 4, 5, and 6 belong to subcarrier group 2; subcarriers 7, 8, and 9 belong to subcarrier group 3; and subcarrier 10, subcarrier 11 and subcarrier 12 belong to subcarrier group 4. The base station determines that a start slot for sending the uplink data transmission grant instruction to the UE1 is T, T1 is 1 ms, T2 is 8 ms, and T3=4*4 ms=16 ms. The base station traverses the 4 subcarriers group, and determines that a subcarrier in a subcarrier group whose start slot is T+1 ms+8 ms and whose end slot is T+1 ms+8 ms+16 ms and that is an idle resource is an available subcarrier. For example, the base station determines that subcarriers 1, 2, 3 in subcarrier group 1 and subcarriers 10, 11, 12 in subcarrier group 4 are available subcarriers. The base station compares a difference between a slot (T+1 ms+8 ms) and an end slot of an allocated resource in the subcarrier group 1, and a difference between a slot (T+1 ms+8 ms) and an end slot of an allocated resource in the subcarrier group 4. For example, if the difference between the slot (T+1 ms+8 ms) and the end slot of the allocated resource in the subcarrier group 1 is less than the difference between the slot (T+1 ms+8 ms) and the end slot of the allocated resource in the subcarrier group 4, it is determined that the subcarriers 1, 2, and 3 in the subcarrier group 1 are target subcarriers.

In an embodiment, the quantity of subcarriers of the base station may not be 12, and single UE may further occupy 6 subcarriers or time-frequency resources of 12 subcarriers. This embodiment of this application provides only an example for description. The quantity of subcarriers of the base station and the quantity of subcarriers occupied by the single UE are not limited in this application.

Further, if it is determined that the target subcarrier exists, S405 is performed; if it is determined that the target subcarrier does not exist, for example, if it is determined that the quantity of available subcarriers is 0, S407 is performed.

S405. The base station determines state transition duration 2 T4.

In an embodiment, the base station determines the state transition duration 2 T4 according to a protocol constraint. For example, in an NB-IoT system, T4 specified in the 3GPP protocol is 3 ms.

S406. The base station sends an uplink data transmission grant instruction to the UE.

In an embodiment, the base station periodically sends the uplink data transmission grant instruction to the UE. For example, a period of sending the uplink data transmission grant instruction is 16 ms. The uplink data transmission grant instruction includes the uplink data transmission grant instruction duration T1, the state transition duration 1 T2, the state transition duration 2 T4, uplink data transmission duration indication information, and the corresponding target subcarrier, where the uplink data transmission duration indication information is used to determine the uplink data transmission duration T3. For example, the uplink data transmission duration indication information may include a quantity of subframes of uplink data transmission and a quantity of subcarriers occupied by single UE.

After receiving the uplink data transmission grant instruction, the UE may determine the uplink data transmission duration T3 based on the uplink data transmission duration indication information. For example, in the uplink data transmission grant instruction, the quantity of subframes of the uplink data transmission is 4, and quantity of subcarriers occupied by the single UE is 1. According to a protocol specification, when the single UE occupies one subcarrier, single-subframe transmission duration is 8 ms. The UE can determine that T3=4*8 ms=32 ms.

A time-frequency resource for performing uplink data transmission may be determined based on the sending moment of the uplink data transmission grant instruction, T1, T2, T3, T4, and the target subcarrier.

S407. The base station determines whether to traverse T2 candidate duration specified in a protocol. If the T2 candidate duration is not traversed, S408 is performed; if the T2 candidate duration has been traversed, S409 is performed.

For example, in an NB-IoT system, T2 candidate duration specified in the 3GPP protocol is {8 ms, 16 ms, 32 ms, 64 ms}. If a current value of T2 is the first state transition duration, for example, T2 is 8 ms, or the value of T2 may be 16 ms, 32 ms, or 64 ms, the T2 candidate duration is not traversed.

S408. The base station re-determines the state transition duration 1 T2. Then, S404 continues to be performed.

In an embodiment, the base station determines that the value of T2 is second state transition duration. For example, the 3GPP protocol specifies that T2 candidate duration is {8 ms, 16 ms, 32 ms, 64 ms}, and a current value of T2 is the first state transition duration, for example, T2 is 8 ms; the base station re-determines that the value of T2 is the second state transition duration, for example, determines that T2 is 16 ms based on an ascending order of T2 candidate duration values.

S409. The base station determines whether the quantity of subframes of the uplink data transmission is 1. If the quantity of subframes of the uplink data transmission is 1, S410 is performed; if the quantity of subframes of the uplink data transmission is not 1, that is, the quantity of subframes of the uplink data transmission is greater than 1, S411 is performed.

S410. The base station does not send an uplink data transmission grant instruction to the UE.

In an embodiment, the base station fails to allocate an uplink data transmission resource and does not send the uplink data transmission grant instruction to the UE.

S411. The base station re-determines the uplink data transmission duration T3.

In an embodiment, the base station re-determines the quantity of subframes of the uplink data transmission, and determines a value of T3 based on the new quantity of subframes of the uplink data transmission.

For example, the current quantity of subframes of the uplink data transmission is the quantity of subframes of the first uplink data transmission, and the quantity of subframes of the first uplink data transmission is 4. A quantity of subframes of second uplink data transmission may be re-determined as the quantity of subframes of the uplink data transmission, where the quantity of subframes of the second uplink data transmission is equal to the quantity of subframes of the first uplink data transmission minus 1, that is, the quantity of subframes of the second uplink data transmission is 3.

The base station determines, based on the quantity of subframes of the second uplink data transmission, that the value of T3 is the duration of the second uplink data transmission. The duration of the second uplink data transmission is equal to the quantity of subframes of the second uplink data transmission multiplied by single-subframe transmission duration.

For example, in an NB-IoT system, a quantity of subcarriers is 12, a quantity of subcarriers that can be occupied by single UE is {1, 3, 6, 12}, and corresponding single-subframe transmission duration is {8 ms, 4 ms, 2 ms, 1 ms}. For example, if single UE performs single-carrier transmission, that is, the single UE occupies a frequency domain resource of one subcarrier, single-subframe transmission duration is 8 ms. T3=3*8 ms.

S412. The base station re-determines the state transition duration 1 T2. Then, S404 continues to be performed.

In an embodiment, the base station re-determines the value of the state transition duration T2 according to a protocol constraint. Optionally, because the base station re-determines the quantity of subframes of the uplink data transmission in S411, and re-determines the value of T3 based on the newly determined quantity of subframes of the uplink data transmission, the base station re-determines the value of T2 as the initial value of the state transition duration. For example, after the re-determining, the value of T2 is third state transition duration, and the third state transition duration is the initial value of the state transition duration.

For example, in an NB-IoT system, T2 candidate duration specified in the 3GPP protocol is {8 ms, 16 ms, 32 ms, 64 ms}. The base station selects the value of T2 based on the ascending order of the T2 candidate duration values. Therefore, the base station determines that the value of T2 is the initial value 8 ms of the state transition duration.

In the uplink transmission resource allocation method according to an embodiment of this application, when an uplink transmission resource is allocated to UE, a subcarrier with a minimum idle fragment resource is selected, and the uplink transmission resource is successfully allocated to the UE as much as possible by reducing a quantity of subframes for current uplink transmission resource allocation. Compared with a method in a current technology in which an uplink transmission resource is allocated to UE by randomly selecting a subcarrier that has an idle resource and resource allocation fails if there is no available subcarrier, the uplink transmission resource allocation method provided in this embodiment of this application can reduce idle fragment resources on a subcarrier, increase an uplink peak rate of a cell, improve spectrum utilization, and reduce node power consumption.

The foregoing mainly describes the solutions provided in the embodiments of this application from a perspective of the base station. It may be understood that, to implement the foregoing functions, the base station includes a corresponding hardware structure and/or software module for performing each of the functions. A person skilled in the art should easily be aware that, in combination with the examples described in the embodiments disclosed in this specification, units and algorithm steps may be implemented by hardware or a combination of hardware and computer software in this application. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

In an embodiment of this application, division of function modules may be performed on the base station based on the foregoing method examples. For example, each function module may be obtained through division based on a corresponding function, or two or more functions may be integrated into one processing module. The integrated module may be implemented in a form of hardware, or may be implemented in a form of a software function module. It should be noted that module division in the embodiments of this application is an example, and is merely a logical function division. In actual implementation, another division manner may be used. An example in which function modules are divided based on functions is used below for description.

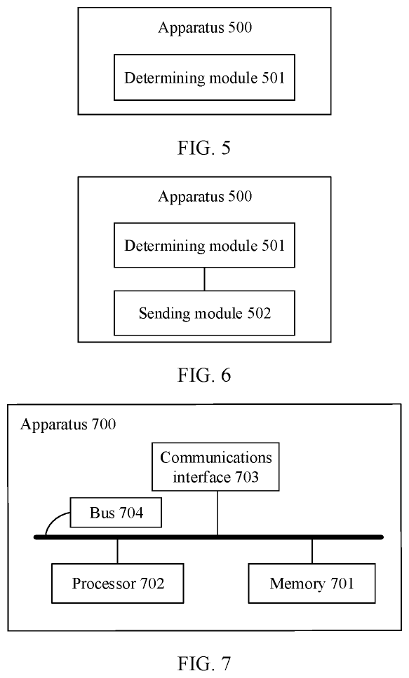

FIG. 5 is a schematic diagram of a logical structure of an apparatus 500 according to an embodiment of this application. The apparatus 500 may be a base station, and can implement functions of the base station in the method provided in the embodiments of this application. The apparatus 500 may also be an apparatus that can support the base station in implementing a function of the base station in the method provided in the embodiments of this application. The apparatus 500 may be a hardware structure, a software module, or a combination of the hardware structure and the software module. The apparatus 500 may be implemented by a chip system. In this embodiment of this application, the chip system may include a chip, or may include a chip and another discrete component. As shown in FIG. 5, the apparatus 500 includes a determining module 501. The determining module 501 may be configured to perform S401, S402, S403, S404, S405, S407, S408, S409, S411, and S412 in FIG. 4A and FIG. 4B, and/or perform other steps described in this application. The determining module may also be referred to as a determining unit or may have another name.

With reference to FIG. 5, as shown in FIG. 6, the apparatus 500 may further include a sending module 502. The sending module 502 may be configured to perform S406 and S410 in FIG. 4A and FIG. 4B, and/or perform other steps described in this application. The sending module may also be referred to as a sending unit or may have another name.

All related content of the operations in the foregoing method embodiments may be cited in function descriptions of corresponding function modules. Details are not described herein again.

In an embodiment, the apparatus 500 may be presented in a form of function modules obtained through division in an integrated manner. The “module” herein may be a specific ASIC, a circuit, a processor executing one or more software or firmware programs, a storage device, an integrated logic circuit, and/or another component that can provide the foregoing functions.

In a simple embodiment, a person skilled in the art may figure out that the apparatus 500 may be in a form shown in FIG. 7.

As shown in FIG. 7, an apparatus 700 may include: a memory 701, a processor 702, and a communications interface 703. The memory 701 is configured to store an instruction. When the apparatus 700 runs, the processor 702 executes the instruction stored in the memory 701, so that the apparatus 700 is enabled to perform the uplink transmission resource allocation method provided in the embodiments of this application. The memory 701, the processor 702, and the communications interface 703 are communicatively connected by using a bus 704. For a specific uplink transmission resource allocation method, refer to the foregoing descriptions and related descriptions in the accompanying drawings. Details are not described herein again. It should be noted that, in a specific implementation process, the apparatus 700 may further include other hardware components, which are not enumerated one by one in this specification. In a possible implementation, the memory 701 may be further included in the processor 702.

In an example of this application, the determining module 501 in FIG. 5 or FIG. 6 may be implemented by using the processor 702, and the sending module 502 in FIG. 6 may be implemented by using the communications interface 703.

The communications interface 703 may be a circuit, a component, an interface, a bus, a software module, a transceiver, or any other apparatus that can implement communication. The processor 702 may be a field-programmable gate array (FPGA), an application-specific integrated circuit (ASIC), a system on chip (SoC), a central processor unit (CPU), a network processor (NP), a digital signal processor (DSP), and a micro controller unit (MCU), and may also be a programmable logic device (PLD) or another integrated chip. The memory 701 includes a volatile memory, for example, a random-access memory (RAM); the memory may also include a non-volatile memory, for example, a flash memory, a hard disk drive (HDD), or a solid-state drive (SSD); the memory may also include a combination of the foregoing types of memories; the memory may also include any other apparatus having a storage function, for example, a circuit, a component, or a software module.

The apparatus provided in this embodiment of this application may be configured to perform the foregoing uplink transmission resource allocation method. Therefore, for technical effects that can be achieved by the apparatus, refer to the foregoing method embodiment. Details are not described herein.

A person of ordinary skill in the art may understand that all or some of the steps of the foregoing methods may be implemented by a program instructing relevant hardware. The program may be stored in a computer-readable storage medium. The storage medium includes: a ROM, a RAM, and an optical disc.

An embodiment of this application further provides a storage medium. The storage medium may include a memory 701.

For explanations and beneficial effects of related content in any one of the foregoing provided apparatuses, refer to the corresponding method embodiment provided above. Details are not described herein again.

All or some of the foregoing embodiments may be implemented through software, hardware, firmware, or any combination thereof. When a software program is used to implement the embodiments, all or some of the embodiments may be implemented in a form of a computer program product. The computer program product includes one or more computer instructions. When the computer program instructions are loaded and executed on a computer, the procedure or functions according to the embodiments of this application are all or partially generated. The computer may be a general-purpose computer, a special-purpose computer, a computer network, a network device, user equipment, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a soft disk, a hard disk, or a magnetic tape), an optical medium (for example, a digital video disc (DVD), a semiconductor medium (for example, a solid-state drive (SSD), or the like.

Although this application is described with reference to the embodiments, in a process of implementing this application that claims protection, a person skilled in the art may understand and implement another variation of the disclosed embodiments by viewing the accompanying drawings, disclosed content, and the accompanying claims. In the claims, “comprising” does not exclude another component or another step, and “a” or “one” does not exclude a meaning of plurality. A single processor or another unit may implement several functions enumerated in the claims. Some measures are recorded in dependent claims that are different from each other, but this does not mean that these measures cannot be combined to produce a better effect.

Although this application is described with reference to specific features and the embodiments thereof, definitely, various modifications and combinations may be made to them without departing from the spirit and scope of this application. Correspondingly, the specification and accompanying drawings are merely example description of this application defined by the accompanying claims, and is considered as any of or all modifications, variations, combinations or equivalents that cover the scope of this application. Definitely, a person skilled in the art can make various modifications and variations to this application without departing from the spirit and scope of this application. This application is intended to cover these modifications and variations of this application provided that they fall within the scope of protection defined by the following claims and their equivalent technologies.

What is claimed is:

1. A method for allocating an uplink transmission resource, comprising:
determining uplink data transmission grant instruction duration, first state transition duration, and duration of first uplink data transmission; and
determining a target subcarrier based on the uplink data transmission grant instruction duration, the first state transition duration, and the duration of the first uplink data transmission, wherein the target subcarrier is an available subcarrier with a minimum difference between a start slot of uplink data transmission duration and an end slot of an allocated resource on an available subcarrier whose resource within the uplink data transmission duration is an idle resource.

2. The method according to claim 1, wherein before determining duration of first uplink data transmission, the method further comprises determining a quantity of subframes of the first uplink data transmission according to a user buffer status report; and
wherein determining duration of first uplink data transmission comprises determining the duration of the first uplink data transmission based on the quantity of subframes of the first uplink data transmission.

3. The method according to claim 1, wherein if it is determined that no target subcarrier exists, the method further comprises:
determining second state transition duration; and
determining the target subcarrier based on the uplink data transmission grant instruction duration, the second state transition duration, and the duration of the first uplink data transmission.

4. The method according to claim 3, wherein if it is determined that no target subcarrier exists, the method further comprises:
determining duration of second uplink data transmission based on a quantity of subframes of the second uplink data transmission, which is equal to a quantity of subframes of the first uplink data transmission minus 1, wherein the quantity of subframes of the first uplink data transmission is an integer greater than 1;
determining third state transition duration representing an initial value of state transition duration; and
determining the target subcarrier based on the uplink data transmission grant instruction duration, the third state transition duration, and the duration of the second uplink data transmission.

5. The method according to claim 1, wherein determining a target subcarrier based on the uplink data transmission grant instruction duration, the first state transition duration, and the duration of the first uplink data transmission comprises:
determining a quantity of available subcarriers based on the uplink data transmission grant instruction duration, the first state transition duration, and the duration of the first uplink data transmission; and
determining the target subcarrier from the available subcarriers.

6. The method according to claim 5, wherein determining that no target subcarrier exists comprises determining that the quantity of the available subcarriers is 0.

7. The method according to claim 1, wherein after the determining the target subcarrier, the method further comprises:
sending an uplink data transmission grant instruction to user equipment, wherein the uplink data transmission grant instruction comprises the uplink data transmission grant instruction duration, the state transition duration, uplink data transmission duration indication information, and the corresponding target subcarrier, wherein the uplink data transmission duration indication information is used to determine the uplink data transmission duration.

8. An apparatus for allocating an uplink transmission resource, comprising: a determining module configured to
determine uplink data transmission grant instruction duration, first state transition duration, and duration of first uplink data transmission;
determine a target subcarrier based on the uplink data transmission grant instruction duration, the first state transition duration, and the duration of the first uplink data transmission, wherein the target subcarrier is an available subcarrier with a minimum difference between a start slot of uplink data transmission duration and an end slot of an allocated resource on an available subcarrier whose resource within the uplink data transmission duration is an idle resource.

9. The apparatus according to claim 8, wherein the determining module is further configured to:
before the determining duration of first uplink data transmission, determine a quantity of subframes of the first uplink data transmission according to a user buffer status report; and
determine the duration of the first uplink data transmission based on the quantity of subframes of the first uplink data transmission.

10. The apparatus according to claim 8, wherein the determining module is configured to:
determine whether the target subcarrier exists;
determine second state transition duration if it is determined that no target subcarrier exists; and
determine the target subcarrier based on the uplink data transmission grant instruction duration, the second state transition duration and the duration of the first uplink data transmission.

11. The apparatus according to claim 10, wherein the determining module is further configured to:
if it is determined that no target subcarrier exists, determine duration of second uplink data transmission based on a quantity of subframes of the second uplink data transmission, which is equal to the quantity of subframes of the first uplink data transmission minus 1, wherein the quantity of subframes of the first uplink data transmission is an integer greater than 1;
determine third state transition duration representing an initial value of state transition duration; and
determine the target subcarrier based on the uplink data transmission grant instruction duration, the third state transition duration, and the duration of the second uplink data transmission.

12. The apparatus according to claim 8, wherein determining the target subcarrier based on the uplink data transmission grant instruction duration, the first state transition duration, and the duration of the first uplink data transmission comprises:
determining a quantity of available subcarriers based on the uplink data transmission grant instruction duration, the first state transition duration, and the duration of the first uplink data transmission; and
determining the target subcarrier from the available subcarriers.

13. The apparatus according to claim 12, wherein determining that no target subcarrier exists comprises determining that the quantity of the available subcarriers is 0.

14. The apparatus according to claim 8, further comprising a sending module configured to send an uplink data transmission grant instruction to user equipment after the determining module determines the target subcarrier, wherein the uplink data transmission grant instruction comprises the uplink data transmission grant instruction duration, the state transition duration, uplink data transmission duration indication information, and the corresponding target subcarrier, wherein the uplink data transmission duration indication information is used to determine the uplink data transmission duration.

15. A network device, comprising:
a processor; and
a memory to store a computer execution instruction, which when executed by the processor, cause the processor to perform operations of allocating uplink transmission resource, the operations comprising:
determining uplink data transmission grant instruction duration, first state transition duration, and duration of first uplink data transmission; and
determining a target subcarrier based on the uplink data transmission grant instruction duration, the first state transition duration, and the duration of the first uplink data transmission, wherein the target subcarrier is an available subcarrier with a minimum difference between a start slot of uplink data transmission duration and an end slot of an allocated resource on an available subcarrier whose resource within the uplink data transmission duration is an idle resource.

16. The network device according to claim 15, wherein before determining duration of first uplink data transmission, the operations further comprise determining a quantity of subframes of the first uplink data transmission according to a user buffer status report; and
wherein determining duration of first uplink data transmission comprises determining the duration of the first uplink data transmission based on the quantity of subframes of the first uplink data transmission.

17. The network device according to claim 15, wherein if it is determined that no target subcarrier exists, the operations further comprise:
determining second state transition duration; and
determining the target subcarrier based on the uplink data transmission grant instruction duration, the second state transition duration, and the duration of the first uplink data transmission.

18. The network device according to claim 17, wherein if it is determined that no target subcarrier exists, the operations further comprise:
determining duration of second uplink data transmission based on a quantity of subframes of the second uplink data transmission, which is equal to a quantity of subframes of the first uplink data transmission minus 1, wherein the quantity of subframes of the first uplink data transmission is an integer greater than 1;
determining third state transition duration representing an initial value of state transition duration; and
determining the target subcarrier based on the uplink data transmission grant instruction duration, the third state transition duration, and the duration of the second uplink data transmission.

19. The network according to claim 15, wherein determining a target subcarrier based on the uplink data transmission grant instruction duration, the first state transition duration, and the duration of the first uplink data transmission comprises:
determining a quantity of available subcarriers based on the uplink data transmission grant instruction duration, the first state transition duration, and the duration of the first uplink data transmission; and
determining the target subcarrier from the available subcarriers.

20. The network device according to claim 19, wherein determining that no target subcarrier exists comprises determining that the quantity of the available subcarriers is 0.
